(19) United States
(12) Patent Application Publication
(10) Pub. No.: US 2025/0298448 A1
(43) Pub. Date: Sep. 25, 2025

(54) ELECTRONIC DEVICE CALCULATING NORMAL TIME INFORMATION, AND METHOD OF OPERATING THE SAME

(71) Applicant: SAMSUNG ELECTRONICS CO., LTD., Suwon-si (KR)

(72) Inventors: Taesun PARK, Suwon-si (KR); Jinbum Lee, Suwon-si (KR); Suckhyun Nam, Suwon-si (KR); Iksung Park, Suwon-si (KR); Hyunglae Eun, Suwon-si (KR)

(73) Assignee: SAMSUNG ELECTRONICS CO., LTD., Suwon-si (KR)

(21) Appl. No.: 18/937,599

(22) Filed: Nov. 5, 2024

(30) Foreign Application Priority Data
Mar. 20, 2024 (KR) 10-2024-0038551

(51) Int. Cl. G06F 1/20; G06F 1/30; G06F 11/30; G11C 14/00; H04L 9/40

(52) U.S. Cl. CPC G06F 1/206; G06F 1/30; G06F 11/3034; G06F 11/3058; G11C 14/00; H04L 63/18

(57) ABSTRACT

A method of operating an electronic device including a storage device and a host device, the method including: performing, by the storage device, thermal shutdown of the storage device based on determining that a first device temperature value exceeds a threshold temperature value; after the thermal shutdown is performed, calculating, by the storage device, temperature trend information using a second device temperature value; calculating, by the storage device, estimated time information indicating an estimated time point at which a temperature of the storage device is estimated to reach a predetermined temperature value, based on the temperature trend information; reading, by the host device, the estimated time information; blocking, by the host device, a power supply voltage from the host device to the storage device based on the estimated time information; and supplying, by the host device, the power supply voltage to the storage device at the estimated time point.

### CROSS-REFERENCE TO RELATED APPLICATIONS

This application is based on and claims priority under 35 U.S.C. § 119 to Korean Patent Application No. 10-2024-0038551 filed on Mar. 20, 2024, in the Korean Intellectual Property Office, the disclosure of which is incorporated by reference herein in its entirety.

### BACKGROUND

### 1. Field

The disclosure described herein relates to an electronic device, and more particularly, an electronic device configured to calculate normal time information and a method of operating the same.

### 2. Description of Related Art

A memory device may store data in response to a write request and output data stored therein in response to a read request. For example, the memory device may be a volatile memory device, which may lose data stored therein when power supplied to the memory device is removed, deactivated, or turned off. Examples of such a volatile memory device include a dynamic random access memory (DRAM) device and a static RAM (SRAM) device. As another example, the memory device may be a non-volatile memory device, which may retain data stored therein even when power supplied to the memory device is removed, deactivated, or turned off. Examples of such a non-volatile memory device include a flash memory device, a phase-change RAM (PRAM), a magnetic RAM (MRAM), and a resistive RAM (RRAM).

A non-volatile memory device may be used in a storage device storing a large amount of data. A host device may supply a power supply voltage to the storage device. While the storage device is driven based on the power supply voltage, a temperature of the storage device may increase based on the power supply voltage. An excessively high temperature may result in at least one of a decrease in an operating speed of the storage device, an error in data stored in the storage device, and physical damage to the storage device.

### SUMMARY

Provided is an electronic device calculating normal time information and a method of operating the same.

Additional aspects will be set forth in part in the description which follows and, in part, will be apparent from the description, or may be learned by practice of the presented embodiments.

In accordance with an aspect of the disclosure, a method of operating an electronic device including a storage device and a host device includes: determining, by the storage device, whether a first device temperature value of the storage device exceeds a threshold temperature value; performing, by the storage device, thermal shutdown of the storage device based on determining that the first device temperature value exceeds the threshold temperature value; after the thermal shutdown is performed, calculating, by the storage device, temperature trend information using a second device temperature value of the storage device; calculating, by the storage device, estimated time information indicating an estimated time point at which a temperature of the storage device is estimated to reach a predetermined temperature value, based on the temperature trend information; reading, by the host device, the estimated time information from the storage device; blocking, by the host device, a power supply voltage from the host device to the storage device based on the estimated time information; and supplying, by the host device, the power supply voltage to the storage device at the estimated time point.

In accordance with an aspect of the disclosure, a method of operating an electronic device including a storage device and a host device includes: determining, by the storage device, whether a first device temperature value of the storage device exceeds a threshold temperature value; performing, by the storage device, thermal shutdown of the storage device based on determining that the first device temperature value exceeds the threshold temperature value; after the thermal shutdown is performed, calculating, by the storage device, temperature trend information using at least two second device temperature values of the storage device; calculating, by the storage device, estimated time information indicating an estimated time point at which a temperature of the storage device is estimated to reach a predetermined temperature value, based on the temperature trend information; reading, by the host device, the estimated time information from the storage device using out-of-band communication between the host device and the storage device; blocking, by the host device, a power supply voltage from being supplied from the host device to the storage device based on the estimated time information; and performing, by the host device, a power-on reset for supplying the power supply voltage to the storage device at the estimated time point.

In accordance with an aspect of the disclosure, an electronic device includes: a storage device; and a host device configured to supply a power supply voltage to the storage device, wherein the storage device is configured to: determine whether a first device temperature value that is increased based on the power supply voltage exceeds a threshold temperature value; perform thermal shutdown based on determining that the first device temperature value exceeds the threshold temperature value; calculate temperature trend information using a second device temperature value that is decreased from the first device temperature value based on the thermal shutdown; and calculate estimated time information indicating an estimated time point at which a temperature of the storage device is estimated to reach a predetermined temperature value, based on the temperature trend information, and wherein the host device is further configured to: read the estimated time information from the storage device; block the power supply voltage based on the estimated time information; and begin supplying the power supply voltage to the storage device again at the estimated time point.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a flowchart describing a method of operating an electronic device according to a comparative example;

FIG. 3 is a flowchart describing a method of operating an electronic device according to some embodiments of the present disclosure;

FIG. 4 is a block diagram of an electronic device according to some embodiments of the present disclosure;

FIG. 5 is a diagram describing a method of operating a storage device of FIG. 4, according to some embodiments of the present disclosure;

FIG. 6 is a diagram describing an operation state and a temperature of a storage device of FIG. 5, according to some embodiments of the present disclosure'

FIG. 7 is a flowchart describing a method of operating an electronic device according to some embodiments of the present disclosure;

FIG. 8 is a block diagram of an electronic device according to some embodiments of the present disclosure;

FIG. 9 is a flowchart describing a method of operating an electronic device according to some embodiments of the present disclosure;

FIG. 10 is a flowchart describing examples of operations of FIG. 9, according to some embodiments of the present disclosure;

FIG. 11 is a flowchart describing examples of operations of FIG. 9, according to some embodiments of the present disclosure; and

FIG. 12 is a flowchart describing examples of operations of FIG. 9, according to some embodiments of the present disclosure.

### DETAILED DESCRIPTION

Below, embodiments of the present disclosure are described in detail and clearly to such an extent that one skilled in the art may carry out embodiments of the present disclosure more easily.

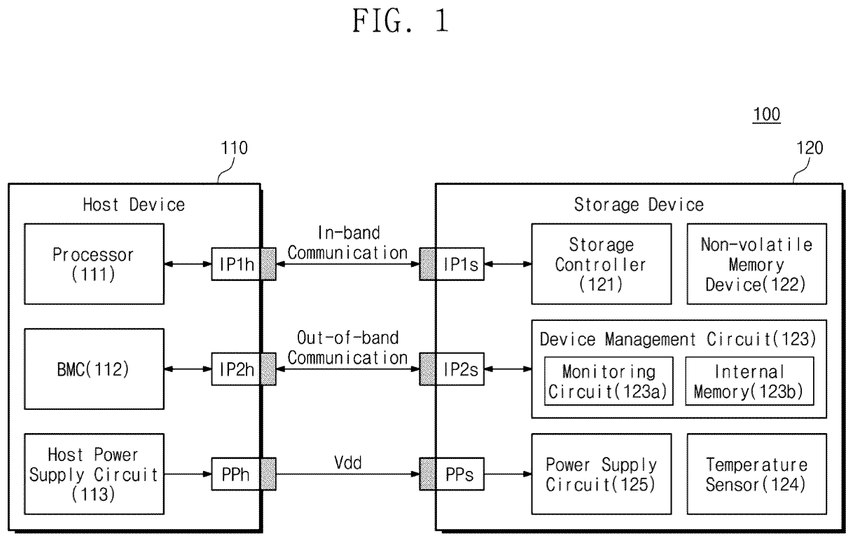

FIG. 1 is a block diagram of an electronic device according to an embodiment of the present disclosure. Referring to FIG. 1, an electronic device 100 may manage various information to be provided to the user, such as an image, a video, a text, and voice. For example, the electronic device 100 may be a computing system which may be configured to process various information, such as a personal computer (PC), a notebook, a laptop, a server, a workstation, a tablet PC, a smartphone, a digital camera, and a black box. As another example, the electronic device 100 may be a storage system, a server system, a database server, etc. for managing a large amount of user data.

The electronic device 100 may include a host device 110 and a storage device 120. The host device 110 may control operations of the electronic device 100. For example, the host device 110 may store data in the storage device 120, may read data stored in the storage device 120, and may delete data stored in the storage device 120. To guarantee the reliability of data stored in the storage device 120, the host device 110 may manage hardware information (e.g., information about a temperature, humidity, a voltage, a current, a device lifetime, etc.) of the storage device 120.

The host device 110 may include a processor 111, a baseboard management controller (BMC) 112, a host power supply circuit 113, a first host interface port IP1h, a second host interface port IP2h, and a host power port PPh. The processor 111 and the BMC 112 may communicate with each other.

The processor 111 may store data in the storage device 120, may read data stored in the storage device 120, and may delete data stored in the storage device 120. For example, the processor 111 may be or may include a central processing unit (CPU). The processor 111 may execute an operating system (OS) and may manage data of the storage device 120 using an executed offset signal. The processor 111 may communicate with the storage device 120 through the first host interface port IP1h.

The BMC 112 may manage the hardware information of the storage device 120. For example, the BMC 112 may receive the hardware information from the storage device 120 and may adjust a physical environment (e.g., a voltage, a current, or a maximum data bandwidth) of the storage device 120 based on the hardware information. The BMC 112 may operate independently of the OS of the processor 111. The BMC 112 may communicate with the storage device 120 through the second host interface port IP2h.

The host power supply circuit 113 may provide a power supply voltage Vdd to the storage device 120 through the host power port PPh. The power supply voltage Vdd may be used to drive the storage device 120. For example, the host power supply circuit 113 may receive an external power supply voltage and may generate the power supply voltage Vdd based on the external power supply voltage. The power supply voltage Vdd may be also referred to as a main power supply voltage.

The storage device 120 may include a storage controller 121, a non-volatile memory device 122, a device management circuit 123, a temperature sensor 124, a power supply circuit 125, a first storage interface port IP1s, a second storage interface port IP2s, and a storage power port PPs.

The storage controller 121 may control operations of the storage device 120, under control of the processor 111. For example, under control of the processor 111, the storage controller 121 may store data in the non-volatile memory device 122, may read data stored in the non-volatile memory device 122, and may delete data stored in the non-volatile memory device 122. The storage controller 121 may communicate with the host device 110 through the first storage interface port IP1s.

The storage controller 121 may include an embedded processor and a volatile memory device. In some embodiments, instead of the processor 111 or in cooperation with the processor 111, the embedded processor may implement at least a portion of a software function and may execute firmware. The volatile memory device may operate as a buffer memory and may be implemented with a static random access memory (SRAM), a dynamic random access memory (DRAM), a synchronous dynamic random access memory (SDRAM), etc.

The storage controller 121 may be driven or powered by an internal power supply voltage provided from the power supply circuit 125. The storage controller 121 may obtain a device temperature value from the temperature sensor 124. The device temperature value may indicate a temperature of the storage device 120, which may be measured by the temperature sensor 124. When it is determined that the device temperature value indicates a high-temperature environment, the storage controller 121 may generate a warning message indicating the high-temperature environment. The high-temperature environment may refer to a state in which the temperature may cause a decrease in the operating speed of the storage device 120, an error of data stored in the storage device 120, or a physical damage of the storage device 120.

The processor 111 of the host device 110 and the storage controller 121 of the storage device 120 may support, or may be configured to perform, in-band communication. For example, the ports IP1h and IP1s may be, or may include, peripheral component interconnect express (PCIe) ports. The processor 111 and the storage controller 121 may support, or may be configured to perform, PCIe-based in-band communication. The in-band communication may be compatible with the OS executable by the processor 111 and may be used to transmit data between the host device 110 and the storage device 120.

The non-volatile memory device 122 may store data under control of the storage controller 121. In some embodiments, the non-volatile memory device 122 may be a NAND flash memory device, but embodiments are not limited thereto. For example, the non-volatile memory device 122 may be one of various storage devices, which retain data stored therein even when a power is turned off, such as a phase-change random access memory (PRAM), a magnetic random access memory (MRAM), a resistive random access memory (RRAM), and a ferroelectric random access memory (FRAM).

The device management circuit 123 may manage the hardware information of the storage device 120. For example, the device management circuit 123 may monitor the hardware information, may store the hardware information, and may provide the hardware information to the host device 110. The device management circuit 123 may communicate with the host device 110 through the second storage interface port IP2s.

The device management circuit 123 may include a monitoring circuit 123a and an internal memory 123b. The monitoring circuit 123a may receive the warning message indicating the high-temperature environment of the storage device 120 from the storage controller 121. The monitoring circuit 123a may perform thermal shutdown of the storage device 120. The thermal shutdown may include blocking the internal power supply voltage which the power supply circuit 125 supplies to the storage controller 121. For example, the thermal shutdown may include blocking or preventing the internal power supply voltage from being supplied by the power supply circuit 125 to the storage controller 121. The thermal shutdown may be also referred to as internal power-off.

After the monitoring circuit 123a performs the thermal shutdown, the monitoring circuit 123a may obtain the device temperature value from the temperature sensor 124, may calculate temperature trend information using the device temperature value, and may calculate normal time information based on the temperature trend information. The temperature trend information may indicate the trend for a temperature of the storage device 120 to decrease after the thermal shutdown is performed. The normal time information may indicate that the thermal shutdown of the storage device 120 has occurred and may indicate a normal time point, which may be a time point at which the temperature of the storage device 120 is estimated to reach a normal temperature value. The normal temperature value may indicate a temperature at which the storage device 120 operates stably or normally and may be determined in advance before the operation of the storage device 120 as a default value in consideration of the performance of the storage device 120. The monitoring circuit 123a may store the normal time information in the internal memory 123b. In some embodiments, the normal temperature value may be referred to as a predetermined temperature value, the normal time point may be referred to as an estimated time point, and the normal time information may be referred to as estimated time information.

The internal memory 123b may store the normal time information received from the monitoring circuit 123a. The internal memory 123b may be implemented with an electrically erasable programmable read-only memory (EEPROM). The normal time information may be implemented as field replaceable unit (FRU) information. The internal memory 123b may be also referred to as an FRU information device.

The BMC 112 of the host device 110 may issue a read request to the internal memory 123b and may read FRU information stored in the internal memory 123b. By periodically checking the FRU information stored in the internal memory 123b, the host device 110 may determine whether the thermal shutdown of the storage device 120 occurs in real time and may block the power supply voltage Vdd. Subsequently, the host device 110 may again supply the power supply voltage Vdd at an accurate point in time when the storage device 120 is estimated to be capable of operating normally (e.g., at a time point corresponding to the normal time information). The operation in which the power supply voltage Vdd is blocked by the host device 110 may be referred to as external power-off.

The BMC 112 of the host device 110 and the device management circuit 123 of the storage device 120 may support, or may be configured to perform, out-of-band communication. For example, the ports IP2h and IP2s may be implemented with system management bus (SMBus) ports. The BMC 112 and the device management circuit 123 may support, or may be configured to perform, SMBus-based out-of-band communication.

In some embodiments, the out-of-band communication may be implemented based on at least one of various kinds of protocols such as an open computer project (OCP) standard, a platform level data model (PLDM) standard, a network controller sideband interface (NC-SI) standard, a Redfish standard, a non-volatile memory express management interface (NVMe_MI) standard, and a management component transport protocol (MCTP) standard.

The electronic device 100 may independently use the in-band communication and the out-of-band communication. A physical path (e.g., a port or a connection line) for the in-band communication may be implemented to be separate from a physical path for the out-of-band communication. A power supply voltage which may be used for the in-band communication may be different from a power supply voltage which may be used for the out-of-band communication. After the thermal shutdown of the storage device 120 is performed, the in-band communication may be deactivated, and the out-of-band communication may be activated.

The temperature sensor 124 may measure a temperature of the storage device 120. Under control of the storage controller 121, the temperature sensor 124 may measure the temperature to determine a device temperature value and may provide the device temperature value to the storage controller 121. Under control of the monitoring circuit 123a, the temperature sensor 124 may measure the temperature to determine the device temperature value and may provide the device temperature value to the monitoring circuit 123a.

The power supply circuit 125 may receive the power supply voltage Vdd from the host device 110 through the storage power port PPh. For example, the ports PPh and PPs may be power ports. The power supply circuit 125 may generate the internal power voltage based on the power supply voltage Vdd. The power supply circuit 125 may provide internal power supply voltages respectively used by function blocks of the storage device 120. The function blocks may refer to components, which perform functions in the storage device 120, such as the storage controller 121 and the non-volatile memory device 122. Under control of the device management circuit 123, the power supply circuit 125 may block at least some of the internal power supply voltages from being supplied to the function blocks.

In some embodiments, the device management circuit 123 and the temperature sensor 124 may be activated even after the thermal shutdown is performed. For example, the device management circuit 123 and the temperature sensor 124 may receive a separate auxiliary power supply voltage, or the thermal shutdown may not block the internal power supply voltage which is supplied to the device management circuit 123 and the temperature sensor 124.

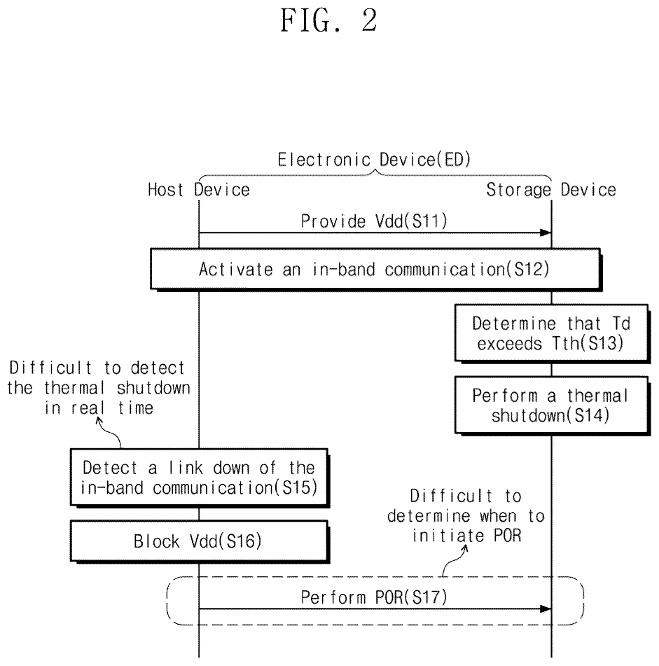

FIG. 2 is a flowchart describing a method of operating an electronic device according to a comparative example. Referring to FIG. 2, a comparative example electronic device ED may include a host device and a storage device. For better understanding of the present disclosure, a comparative example electronic device ED is described below, but the comparative example electronic device ED is not intended to limit the scope of the present disclosure.

At operation S11, the host device may provide the power supply voltage Vdd to the storage device. The storage device may generate an internal power supply voltage based on the power supply voltage Vdd and may drive a storage controller of the storage device using the internal power supply voltage.

At operation S12, the in-band communication between a processor of the host device and the storage controller of the storage device may be activated.

At operation S13, while the storage device is driven or powered based on the power supply voltage Vdd, a temperature of the storage device may increase based on the power supply voltage Vdd. The storage device may measure a temperature of the storage device to determine a device temperature value Td and may determine that the device temperature value Td exceeds a threshold temperature value Tth. The threshold temperature value Tth may refer to an excessively high temperature capable of causing the decrease in the operating speed of the storage device, causing an error of data stored in the storage device, or causing a physical damage of the storage device. The threshold temperature value Tth may be determined in advance before the operation of the storage device as a default value in consideration of the performance of the storage device.

At operation S14, the storage device may perform the thermal shutdown. The thermal shutdown may include blocking the internal power supply voltage from being supplied to the storage controller. After the thermal shutdown is performed, the storage controller may be deactivated, and the temperature of the storage device may decrease.

At operation S15, the host device may detect link-down of the in-band communication. In embodiments, link-down may refer to a loss of connection or communication. The host device may determine that the thermal shutdown of the storage device occurs, based on detecting the link-down. For example, the host device may provide a request to the storage controller through the in-band communication and may then fail to receive a response corresponding to the request from the storage controller. The host device may detect the thermal shutdown of the storage device based on failing to receive the response.

In this case, because the host device only detects the thermal shutdown indirectly based on the link-down and does not periodically check the thermal shutdown of the storage device, it may be difficult for the host device to detect the thermal shutdown of the storage device in real time.

At operation S16, the host device may block the power supply voltage Vdd being supplied to the storage device.

At operation S17, the host device may perform a power-on reset (POR). The power-on reset may include supplying the power supply voltage Vdd to the storage device. Because the host device fails to detect an accurate point in time when the thermal shutdown occurs at operation S15, and does not have information about a temperature trend of the storage device, it may be difficult for the host device to determine a time point appropriate for initiating the power-on reset (e.g., a point in time when the temperature of the storage device reaches a normal temperature value after the thermal shutdown).

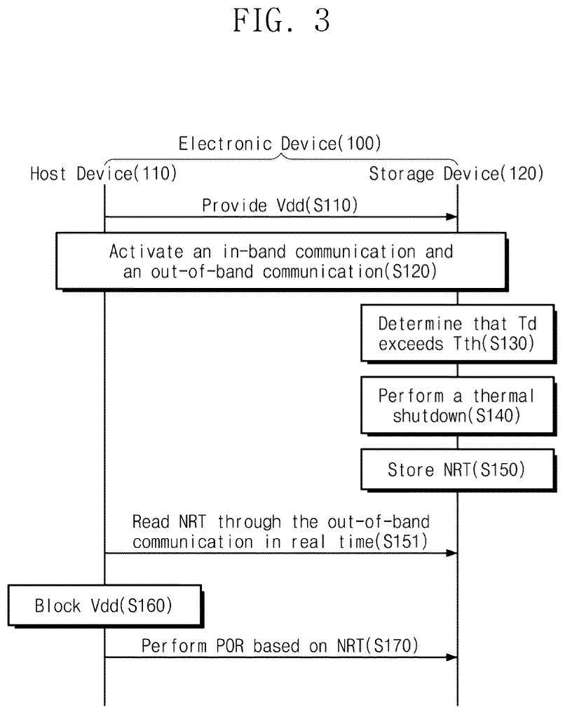

FIG. 3 is a flowchart describing a method of operating an electronic device according to some embodiments of the present disclosure. Referring to FIGS. 1 and 3, the electronic device 100 may include the host device 110 and the storage device 120.

At operation S110, the host device 110 may provide the power supply voltage Vdd to the storage device 120. The power supply circuit 125 of the storage device 120 may generate the internal power supply voltage based on the power supply voltage Vdd and may drive the storage controller 121 using the internal power supply voltage. In some embodiments, the host device 110 may further provide the storage device 120 with an auxiliary power supply voltage which may be used to drive the device management circuit 123 and the temperature sensor 124. For example, the host device 110 may provide the auxiliary voltage to at least one of the storage device 120, the device management circuit 123, and the temperature sensor 124.

At operation S120, the in-band communication between the processor 111 of the host device 110 and the storage controller 121 of the storage device 120 may be activated. The in-band communication may be based on the power supply voltage Vdd. The out-of-band communication between the BMC 112 of the host device 110 and the device management circuit 123 of the storage device 120 may be activated. In some embodiments, the out-of-band communication may be based on the auxiliary power supply voltage.

At operation S130, while the storage device 120 is driven based on the power supply voltage Vdd, the temperature of the storage device 120 may increase based on the power supply voltage Vdd. The storage controller 121 may obtain the device temperature value Td from the temperature sensor 124, may determine that the device temperature value Td exceeds the threshold temperature value Tth, and may provide the warning message to the monitoring circuit 123a.

At operation S140, the monitoring circuit 123a of the storage device 120 may perform the thermal shutdown. The thermal shutdown may include blocking the internal power supply voltage supplied to the storage controller 121 from the power supply circuit 125. For example, the internal power supply voltage may be blocked or prevented from being supplied to the power supply circuit 125. After the thermal shutdown is performed, the storage controller 121 may be deactivated. The temperature of the storage device 120 may decrease.

At operation S150, the monitoring circuit 123a may obtain a device temperature value from the temperature sensor 124 after the thermal shutdown is performed, may calculate temperature trend information indicating the trend for a temperature of the storage device 120 to decrease, may calculate normal time information NRT indicating a normal time point, which may be a time point at which the temperature of the storage device 120 is estimated to reach a normal temperature value, using the temperature trend information, and may store the normal time information NRT in the internal memory 123b.

At operation S151, the host device 110 may periodically monitor the internal memory 123b through the out-of-band communication and may read the normal time information NRT stored in the internal memory 123b in real time. Unlike the comparative example in which the electronic device ED of FIG. 2 detects the thermal shutdown indirectly through the detection of the link-down, the host device 110 may check the normal time information NRT in real time through the out-of-band communication, which may be different from the in-band communication deactivated by the thermal shutdown, and thus, the host device 110 may determine whether the thermal shutdown of the storage device 120 occurs in real time.

At operation S160, the host device 110 may block or prevent the power supply voltage Vdd from being supplied to the storage device 120.

At operation S170, the host device 110 may perform the power-on reset POR. Unlike the comparative example in which it is difficult for the electronic device ED of FIG. 2 to determine a time point to initiate the power-on reset POR, the host device 110 may again supply the power supply voltage Vdd at an accurate point in time when the storage device 120 is estimated to be capable of operating normally, by considering the temperature trend of the storage device 120 based on the normal time information NRT read at operation S151.

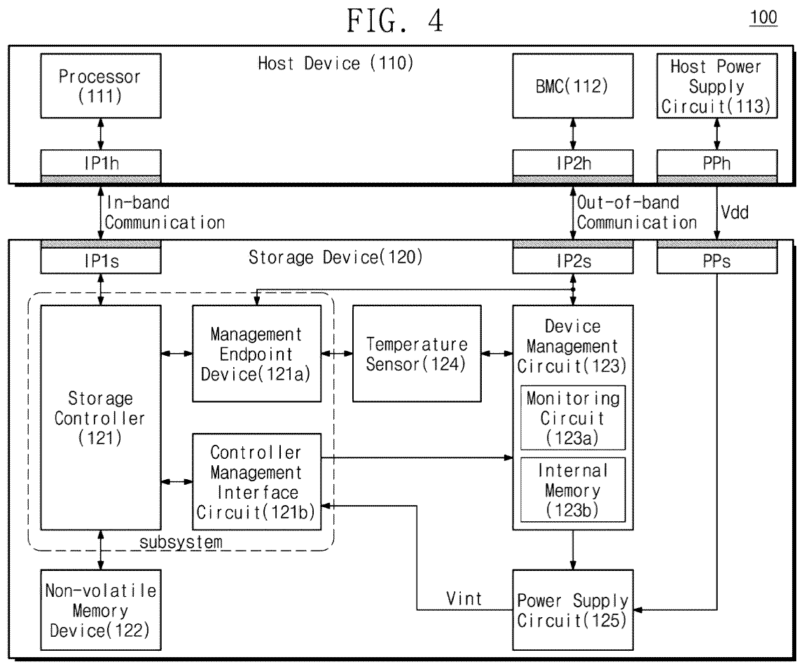

FIG. 4 is a block diagram of an electronic device according to some embodiments of the present disclosure. Referring to FIG. 4, the electronic device 100 may include the host device 110 and the storage device 120.

The host device 110 may include the processor 111, the BMC 112, the host power supply circuit 113, the first host interface port IP1h, the second host interface port IP2h, and the host power port PPh. The processor 111 may perform the in-band communication with the storage device 120 through the first host interface port IP1h. The BMC 112 may perform the out-of-band communication with the storage device 120 through the second host interface port IP2h. The host power supply circuit 113 may supply the power supply voltage Vdd to the storage device 120 through the host power port PPh.

The storage device 120 may include the storage controller 121, a management endpoint device 121a, a controller management interface circuit 121b, the non-volatile memory device 122, the device management circuit 123, the temperature sensor 124, the power supply circuit 125, the first storage interface port IP1s, the second storage interface port IP2s, and the storage power port PPs.

The storage controller 121 may perform the in-band communication with the host device 110 through the first storage interface port IP1s. The storage controller 121 may communicate with the management endpoint device 121a, the controller management interface circuit 121b, and the non-volatile memory device 122.

The storage controller 121, the management endpoint device 121a, and the controller management interface circuit 121b may be collectively referred to as a subsystem. The management endpoint device 121a may share data transmitted by the device management circuit 123 with the storage controller 121. The management endpoint device 121a may share a device temperature value measured by the temperature sensor 124 with the storage controller 121. The controller management interface circuit 121b may provide an internal power supply voltage Vint received from the power supply circuit 125 to the storage controller 121. The controller management interface circuit 121b may provide an interface between the storage controller 121 and the device management circuit 123. For example, the storage controller 121 may provide the warning message to the device management circuit 123 through the controller management interface circuit 121b.

The non-volatile memory device 122 may store data under control of the storage controller 121. The data of the non-volatile memory device 122 may be transmitted through the in-band communication.

The device management circuit 123 may perform the out-of-band communication with the host device 110 through the second storage interface port IP2s. The device management circuit 123 may share the data transmitted to the management endpoint device 121a. The device management circuit 123 may obtain a device temperature value from the temperature sensor 124. The device management circuit 123 may control the power supply circuit 125. The device management circuit 123 may include the monitoring circuit 123a and the internal memory 123b.

The temperature sensor 124 may measure the temperature of the storage

device 120 and may generate the device temperature value. The temperature sensor 124 may provide the device temperature value to the management endpoint device 121a. The temperature sensor 124 may provide the device temperature value to the device management circuit 123.

The power supply circuit 125 may receive the power supply voltage Vdd from the host device 110 through the storage power port PPh. The power supply circuit 125 may generate the internal power voltage Vint based on the power supply voltage Vdd. The power supply circuit 125 may supply the internal power supply voltage Vint to the controller management interface circuit 121b. Under control of the device management circuit 123, the power supply circuit 125 may stop supplying the internal power supply voltage Vint.

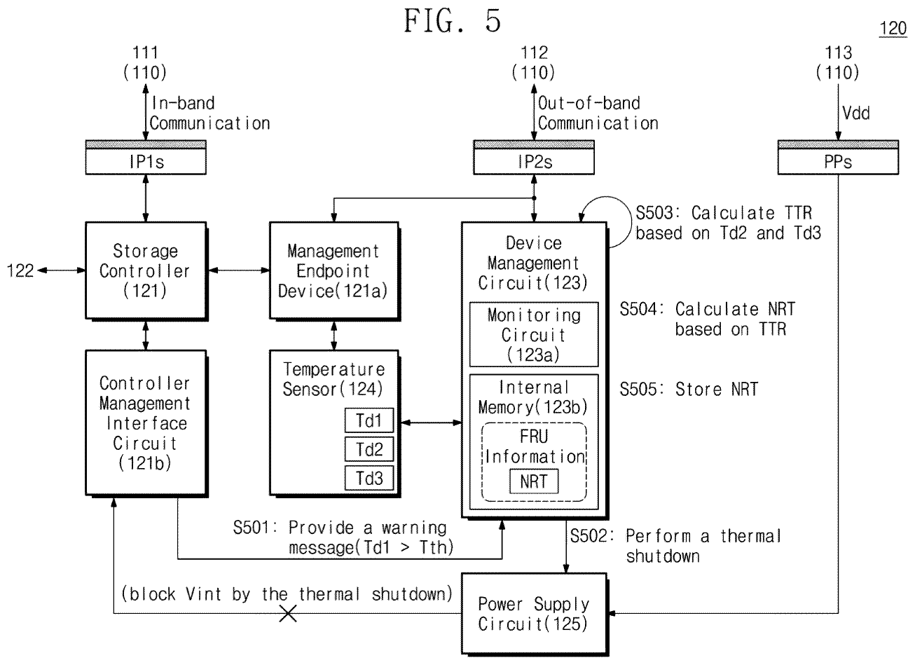

FIG. 5 is a diagram describing a method of operating a storage device of FIG. 4, according to some embodiments of the present disclosure. Referring to FIGS. 4 and 5, the storage device 120 may communicate with the host device 110.

The storage device 120 may include the storage controller 121, the management endpoint device 121a, the controller management interface circuit 121b, the non-volatile memory device 122, the device management circuit 123, the temperature sensor 124, the power supply circuit 125, the first storage interface port IP1s, the second storage interface port IP2s, and the storage power port PPs.

The first storage interface port IP1s may be used for the in-band communication with the processor 111 of the host device 110. The second storage interface port IP2s may be used for the out-of-band communication with the BMC 112 of the host device 110. The storage power port PPs may be used to receive the power supply voltage Vdd from the host power supply circuit 113 of the host device 110. The device management circuit 123 may include the monitoring circuit 123a and the internal memory 123b.

Below, an example of a method of operating the storage device 120 is described.

At operation S501 the temperature sensor 124 may measure a temperature of the storage device 120 to generate a first device temperature value Td1. The storage controller 121 may obtain the first device temperature value Td1 from the temperature sensor 124 through the management endpoint device 121a. The storage controller 121 may compare the first device temperature value Td1 to the threshold temperature value Tth, may determine that the first device temperature value Td1 exceeds the threshold temperature value Tth, and may provide the warning message to the device management circuit 123 through the controller management interface circuit 121b. The warning message may indicate a high-temperature environment of the storage device 120.

At operation S502, the monitoring circuit 123a of the device management circuit 123 may perform the thermal shutdown of the storage device 120 based on the warning message. The thermal shutdown may be referred to as internal power-off. The thermal shutdown may include deactivating the power supply circuit 125. The internal power supply voltage Vint which may be supplied from the power supply circuit 125 to the controller management interface circuit 121b may be blocked by the thermal shutdown. For example, the internal power supply voltage Vint may be blocked or prevented from being provided to one or more of the components included in the storage device 120 based on the thermal shutdown being performed. After the thermal shutdown is performed, the temperature of the storage device 120 may decrease.

At operation S503, the temperature sensor 124 may measure a temperature of the storage device 120 after the execution of the thermal shut-down and may generate a second device temperature value Td2. The monitoring circuit 123a may obtain the second device temperature value Td2 from the temperature sensor 124. After the temperature sensor 124 generates the second device temperature value Td2, the temperature sensor 124 may measure a temperature of the storage device 120 to generate a third device temperature value Td3. The monitoring circuit 123a may receive the third device temperature value Td3 from the temperature sensor 124. The monitoring circuit 123a may generate temperature trend information TTR based on the second device temperature value Td2 and the third device temperature value Td3. After the thermal shutdown is performed, the temperature trend information TTR may indicate the trend for a temperature of the storage device 120 to decrease.

At operation S504 the monitoring circuit 123a may calculate the normal time information NRT based on the temperature trend information TTR. The normal time information NRT may indicate that the thermal shutdown of the storage device 120 has occurred, and may indicate a normal time point at which the temperature of the storage device 120 is estimated to reach a normal temperature value.

At operation S505 the monitoring circuit 123a may store the normal time information NRT in the internal memory 123b as FRU information. The BMC 112 of the host device 110 112 may periodically monitor the internal memory 123b through the out-of-band communication and may read the FRU information stored in the internal memory 123b in real time. For example, immediately after the internal memory 123b stores the normal time information NRT, the BMC 112 of the host device 110 may read the normal time information NRT from the internal memory 123b through the out-of-band communication.

Subsequently, the host device 110 may block or prevent the power supply voltage Vdd from being supplied to the storage device 120 based on the normal time information NRT. The blocking of the power supply voltage Vdd may be also referred to as external power-off. After the host device 110 blocks the power supply voltage Vdd, the host device 110 may supply the power supply voltage Vdd to the storage device 120 at a normal time point indicated by the normal time information NRT. The supplying of the power supply voltage Vdd may be referred to as a power-on reset (POR).

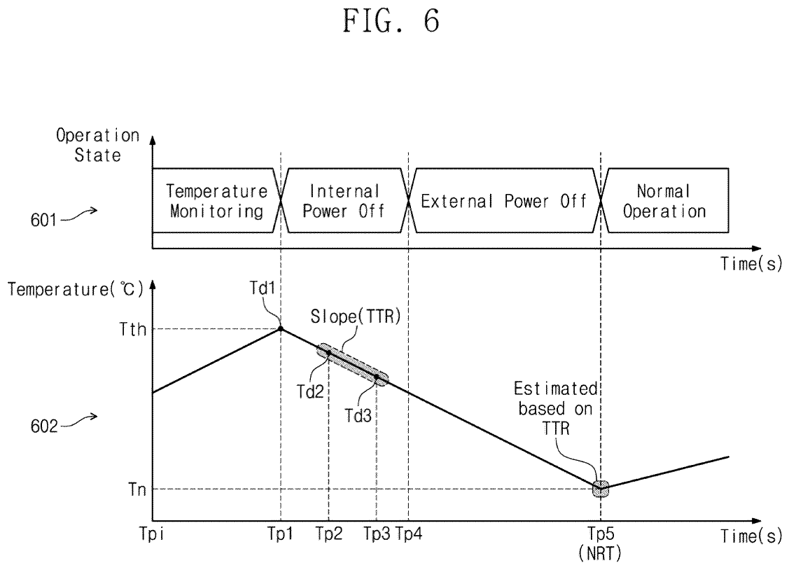

FIG. 6 is a diagram describing an operation state and a temperature of a storage device of FIG. 5, according to some embodiments of the present disclosure. In particular, FIG. 6 includes an operation state graph 601 and a temperature graph 602.

Referring to FIGS. 5 and 6, the storage device 120 may communicate with the host device 110. In the operation state graph 601 shown in FIG. 6, the horizontal axis may represent a time, and the unit of time may be seconds. In the temperature graph 602 shown in FIG. 6, the horizontal axis may represent a time, and the unit of time may be seconds. In addition, the vertical axis the temperature graph 602 shown in FIG. 6 may represent a temperature, and the unit of temperature may be Celsius.

At an initial time point Tpi, the storage device 120 may be driven by the power supply voltage Vdd received from the host device 110. The in-band communication and out-of-band communication of the storage device 120 may be activated. A temperature of the storage device 120 may increase based on the power supply voltage Vdd. The storage controller 121 may perform temperature monitoring. The temperature monitoring may include obtaining, at the storage controller 121, a device temperature value from the temperature sensor 124 and determining whether the device temperature value exceeds the threshold temperature value Tth.

At a first time point Tp1, the temperature sensor 124 may measure a temperature of the storage device 120 to generate the first device temperature value Td1. The storage controller 121 may obtain the first device temperature value Td from the temperature sensor 124 and may determine that first the device temperature value Td1 exceeds the threshold temperature value Tth. The storage controller 121 may provide the warning message to the monitoring circuit 123a. The monitoring circuit 123a may perform the thermal shutdown of the storage device 120 based on the warning message. The thermal shutdown may be referred to as internal power-off. After the thermal shutdown is performed, the temperature of the storage device 120 may decrease.

At a second time point Tp2, the temperature sensor 124 may measure a temperature of the storage device 120 to generate the second device temperature value Td2. Because the temperature of the storage device 120 may be decreased by the thermal shutdown, the second device temperature value Td2 may be smaller or lower than the first device temperature value Td1. The monitoring circuit 123a may obtain the second device temperature value Td2 from the temperature sensor 124.

At a third time point Tp3, the temperature sensor 124 may measure a temperature of the storage device 120 to generate the third device temperature value Td3. Because the temperature of the storage device 120 may be decreased by the thermal shutdown, the third device temperature value Td3 may be smaller than the second device temperature value Td2. The monitoring circuit 123a may obtain the third device temperature value Td3 from the temperature sensor 124.

Subsequently, the monitoring circuit 123a may calculate the temperature trend information TTR based on the second device temperature value Td2 and the third device temperature value Td3. The temperature trend information TTR may describe the relationship between a time and a temperature of the storage device 120. The monitoring circuit 123a may generate the normal time information NRT indicating a normal time point at which the temperature of the storage device 120 is estimated to reach a normal temperature value Tn, based on the temperature trend information TTR.

In some embodiments, the temperature trend information TTR may include slope information. For example, the monitoring circuit 123a may obtain the slope information by dividing a first difference value indicating a difference between the third device temperature value Td3 and the second device temperature value Td2, by a second difference value indicating a difference between the third time point Tp3 and the second time point Tp2. The monitoring circuit 123a may generate the temperature trend information TTR including a temperature trend function based on the slope information.

For example, the temperature trend function may be a linear function describing the relationship between one or more times and one or more temperatures of the storage device 120. The temperature trend function may be defined by the slope information and intercept information. The monitoring circuit 123a may generate the normal time information NRT indicating a fifth time point Tp5, which may be a time point at which the temperature of the storage device 120 reaches the normal temperature value Tn, using the temperature trend function described by the temperature trend information TTR.

At a fourth time point Tp4, the monitoring circuit 123a may store the normal time information NRT as FRU information in the internal memory 123b. The host device 110 may read the normal time information NRT of the internal memory 123b through the out-of-band communication in real time. The host device 110 may block the power supply voltage Vdd in based on the normal time information NRT, for example based on reading the normal time information NRT. The blocking of the power supply voltage Vdd may be also referred to as external power-off.

At the fifth time point Tp5, the host device 110 may supply the power supply voltage Vdd to the storage device 120 at a normal time point (e.g., the fifth time point Tp5) indicated by the normal time information NRT. Subsequently, the storage device 120 may perform a normal operation. A temperature of the storage device 120 may increase based on the power supply voltage Vdd. The storage device 120 may perform the temperature monitoring (e.g., an operation between points in time Tpi and Tp1) in parallel with the normal operation, or may perform the temperature monitoring after the temperature of the storage device 120 reaches an arbitrary temperature (e.g., an arbitrary temperature between the threshold temperature value Tth and the normal temperature value Tn) at which the temperature monitoring will be triggered.

The operations in which the monitoring circuit 123a calculates the temperature trend information TTR using the second and third device temperature values Td2 and Td3 are described for better understanding of the present disclosure, but methods of calculating the temperature trend information TTR may be variously changed and modified by one skilled in the art.

Unlike the description given with reference to the graphs, for example, during the internal power-off, the monitoring circuit 123a may calculate the temperature trend information TTR including the temperature trend function through a linear regression analysis or a non-linear regression analysis which is based on two or more device temperature values. As another example, the monitoring circuit 123a may only obtain the second device temperature value Td2 after the thermal shutdown, may obtain the slope information based on the first and second device temperature values Td1 and Td2, and may generate the temperature trend information TTR including the temperature trend function based on the slope information.

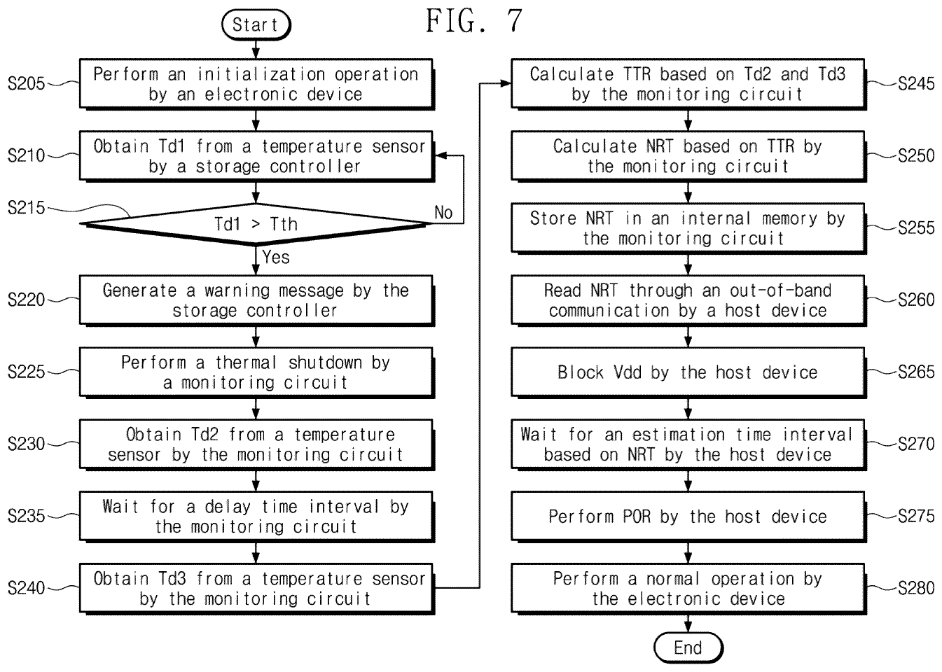

FIG. 7 is a flowchart describing a method of operating an electronic device according to some embodiments of the present disclosure. Referring to FIG. 7, an electronic device may include a host device and a storage device. In embodiments, the host device may correspond to the host device 110, and the storage device may correspond to the storage device S120.

At operation S205, the electronic device may perform an initialization

operation. The initialization operation may include providing, at the host device, the power supply voltage Vdd to the storage device, activating the in-band communication between the host device and the storage device, and activating the out-of-band communication between the host device and the storage device.

The storage device may include a storage controller and a temperature sensor. In embodiments, the storage controller may correspond to the storage controller 121, and the temperature sensor may correspond to the temperature sensor 124. At operation S210, the storage controller may obtain the first device temperature value Td1 from the temperature sensor.

At operation S215, the storage controller may determine whether the first device temperature value Td1 exceeds a threshold temperature value. When the first device temperature value Td1 does not exceed the threshold temperature value (“No” at operation S215), the storage device 120 may repeat operation S210. When the first device temperature value Td1 exceeds the threshold temperature value (“Yes” at operation S215), the storage device 120 may perform operation S220.

At operation S220, the storage controller may generate the warning message. The warning message may indicate a high-temperature environment of the storage device. The storage controller may provide the warning message to a monitoring circuit of the storage device. In embodiments, the monitoring circuit may correspond to the monitoring circuit 123a.

At operation S225, the monitoring circuit may perform the thermal shutdown based on the warning message. The thermal shutdown may include blocking, at a power supply circuit of the storage device, a power supply voltage from being supplied to the storage controller. In embodiments, the power supply circuit may correspond to the power supply circuit 125. The in-band communication may be deactivated by the thermal shutdown. At operation S230, the temperature sensor may generate the second device temperature value Td2 after the execution of the thermal shutdown. The monitoring circuit may obtain the second device temperature value Td2 from the temperature sensor.

At operation S235, the monitoring circuit may wait for a delay time interval. The delay time interval may be an interval set to analyze a temperature trend after the thermal shutdown. For example, the delay time interval may correspond to an interval between the second time point Tp2 and the third time point Tp3 of FIG. 6.

At operation S240, the temperature sensor may generate the third device

temperature value Td3 after the delay time interval passes. The monitoring circuit may obtain the third device temperature value Td3 from the temperature sensor.

At operation S245, the monitoring circuit may calculate the temperature trend information TTR based on the second device temperature value Td2 and the third device temperature value Td3. The temperature trend information TTR may indicate the trend for a temperature of the storage device 120 to decrease after the execution of the thermal shutdown. For example, the temperature trend information TTR may include slope information of the temperature trend function describing the relationship between a temperature and a time after the execution of the thermal shutdown

At operation S250, the monitoring circuit may calculate the normal time information NRT based on the temperature trend information TTR. The normal time information NRT may indicate that the thermal shutdown of the storage device 120 has occurred, and may indicate a normal time point at which the temperature of the storage device 120 is estimated to reach the normal temperature value.

At operation S255, the monitoring circuit may store the normal time information NRT based on an internal memory of the storage device. The internal memory may support, or may be configured to perform, the out-of-band communication with a BMC of the host device. In embodiments, the internal memory may correspond to the internal memory 123b.

At operation S260, the host device may read the normal time information NRT stored in the internal memory through the out-of-band communication. For example, the host device may periodically monitor the internal memory through the out-of-band communication. The host device may check the normal time information NRT stored in the internal memory in real time.

At operation S265, the host device may block the power supply voltage Vdd being supplied to the storage device.

At operation S270, the host device may wait for an estimation time interval based on the normal time information NRT. The estimation time interval may be an interval from the point in time when the power supply voltage Vdd is blocked to the normal time point indicated by the normal time information NRT. For example, the estimation time interval may correspond to an interval between the fourth time point Tp4 and the fifth time point Tp5 of FIG. 6.

At operation S275, the host device may perform the power-on reset (POR). For example, immediately after the estimation time interval passes, or at the normal time point indicated by the normal time information NRT, the host device may again supply the power supply voltage Vdd to the storage device.

At operation S280, the electronic device may perform the normal operation based on the power supply voltage Vdd supplied depending on the power-on reset (POR). For example, the host device may store data in the storage device, may read the stored data, and may delete the stored data.

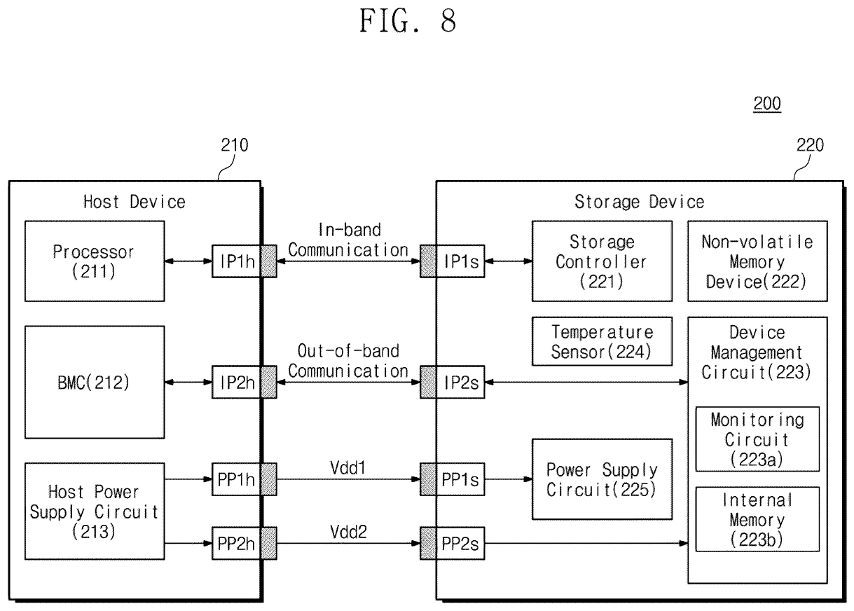

FIG. 8 is a block diagram of an electronic device according to some embodiments of the present disclosure. Referring to FIG. 8, an electronic device 200 may include a host device 210 and a storage device 220.

The host device 210 may include a processor 211, a BMC 212, a host power supply circuit 213, the first host interface port IP1h, the second host interface port IP2h, a first host power port PP1h, and a second host power port PP2h. The processor 211, the BMC 212, the first host interface port IP1h, and the second host interface port IP2h may be similar to the processor 111, the BMC 112, the first host interface port IP1h, and the second host interface port IP2h of FIG. 4, and thus, additional description may be omitted to avoid redundancy.

The storage device 220 may include a storage controller 221, a non-volatile memory device 222, a device management circuit 223, a temperature sensor 224, a power supply circuit 225, the first storage interface port IP1s, the second storage interface port IP2s, a first storage power port PP1s, and a second storage power port PP2s. The storage controller 121, the non-volatile memory device 222, the temperature sensor 224, the first storage interface port IP1s, and the second storage interface port IP2s may be respectively similar to the storage controller 221, the non-volatile memory device 122, the temperature sensor 124, the first storage interface port IP1s, and the second storage interface port IP2s of FIG. 4, and thus, additional description may be omitted to avoid redundancy.

The host power supply circuit 213 may generate a first power supply voltage Vdd1 and a second power supply voltage Vdd2 based on an external power supply voltage. The second power supply voltage Vdd2 may be different from the first power supply voltage Vdd1. A voltage level of the first power supply voltage Vdd1 may be higher than a voltage level of the second power supply voltage Vdd2. The first power supply voltage Vdd1 may be referred to as a main power supply voltage, and the second power supply voltage Vdd2 may be referred to as an auxiliary power supply voltage.

The host power supply circuit 213 may provide the first power supply voltage Vdd1 to the storage device 220 through the first host power port PP1h. The host power supply circuit 213 may provide the second power supply voltage Vdd2 to the storage device 220 through the second host power port PP2h. For example, the first and second power supply voltages Vdd1 and Vdd2 may be provided to the storage device 220 through separate power lines.

The device management circuit 223 may perform the out-of-band communication with the host device 210 through the second storage interface port IP2s. The device management circuit 223 may receive the second power supply voltage Vdd2 from the host device 210 through the second storage power port PP2s. The device management circuit 223 may include a monitoring circuit 223a and an internal memory 223b. The monitoring circuit 223a and the internal memory 223b may operate similarly to the monitoring circuit 123a and the internal memory 123b of FIG. 4.

In some embodiments, the host device 210 may always supply the second power supply voltage Vdd2 to the storage device 220. For example, even if the thermal shutdown of the storage device 220 is performed, the second power supply voltage Vdd2 which is supplied to the device management circuit 223 may not be blocked. The monitoring circuit 223a may perform the thermal shutdown of the storage device 220 based on the second power supply voltage Vdd2 being a constant power supply voltage, may obtain a device temperature value from the temperature sensor 224, may calculate temperature trend information, may calculate normal time information, and may store the normal time information in the internal memory 223b.

The internal memory 223b may be driven or powered based on the second power supply voltage Vdd2 being a constant power supply voltage. The internal memory 223b may receive a read request from the BMC 212 through the out-of-band communication and may provide normal time information to the BMC 212 through the out-of-band communication in response to the read request.

The power supply circuit 225 may receive the first power supply voltage Vdd1 from the host device 210 through the first storage power port PP1s. The power supply circuit 225 may provide an internal power supply voltage to the storage controller 221 based on the first power supply voltage Vdd1. When the monitoring circuit 223a performs the thermal shutdown, the power supply circuit 225 may block the internal power supply voltage from being supplied to the storage controller 221 under control of the monitoring circuit 223a.

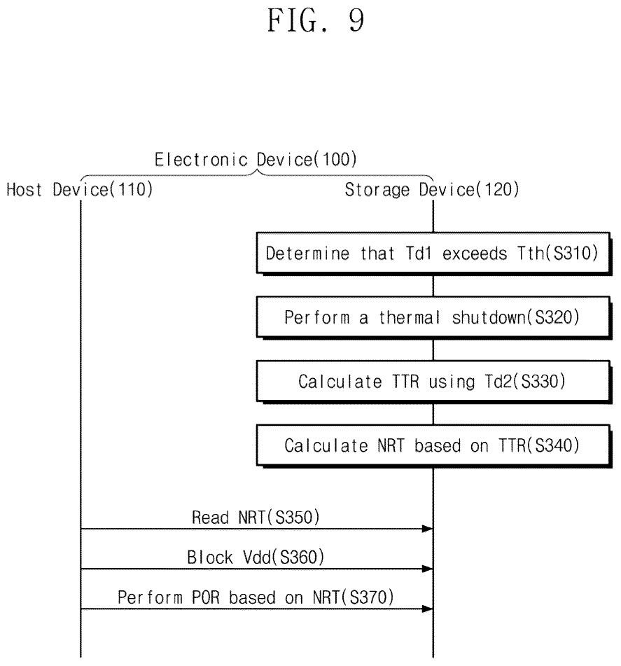

FIG. 9 is a flowchart describing a method of operating an electronic device according to some embodiments of the present disclosure. Referring to FIG. 9, the electronic device 100 may include the host device 110 and the storage device 120.

At operation S310, the storage device 120 may determine that the first device temperature value Td1 exceeds the threshold temperature value Tth. The first device temperature value Td1 may indicate that the temperature of the storage device 120 is increased based on a power supply voltage received from the host device 110. The threshold temperature value Tth may provide a criterion for determining a high-temperature environment.

At operation S320, the storage device 120 may perform the thermal shutdown based on determining that the first device temperature value Td1 exceeds the threshold temperature value Tth. For example, the storage device 120 may receive the power supply voltage from the host device 110 and may provide the internal power supply voltage to a storage controller of the storage device 120 based on the power supply voltage. The thermal shutdown may include blocking the internal power supply voltage being supplied to the storage controller. After the thermal shutdown is performed, the temperature of the storage device 120 may decrease. The thermal shutdown may be referred to as internal power-off.

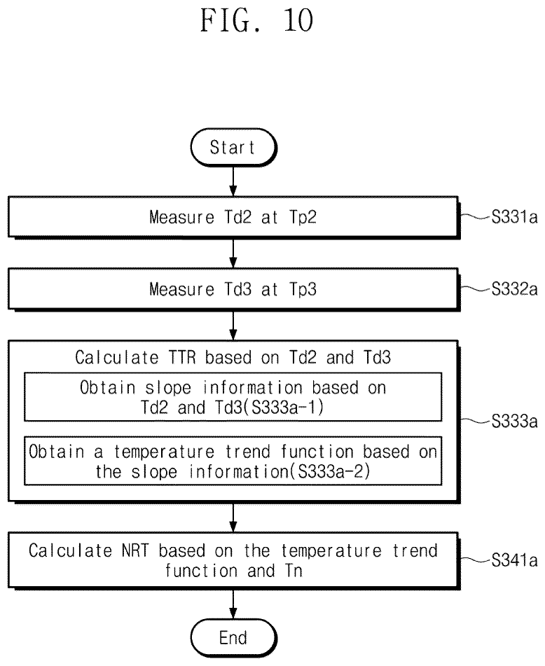

At operation S330, the storage device 120 may calculate the temperature trend information TTR using the second device temperature value Td2. The second device temperature value Td2 may indicate the temperature of the storage device 120 measured after the thermal shutdown is performed. The temperature trend information TTR may indicate the trend for a temperature of the storage device 120 to decrease after the execution of the thermal shutdown. Examples of operations for calculating the temperature trend information TTR are described in detail with reference to FIGS. 10, 11, and 12.

At operation S340, the storage device 120 may calculate the normal time information NRT based on the temperature trend information TTR. The normal time information NRT may indicate a normal time point at which the temperature of the storage device 120 is estimated to reach the normal temperature value. The storage device 120 may store the normal time information NRT.

At operation S350, the host device 110 may read the normal time information NRT from the storage device 120. For example, the host device 110 may periodically provide the read request to an internal memory of the storage device 120 through the out-of-band communication and may receive the normal time information NRT from the internal memory. The out-of-band communication may be maintained even after the thermal shutdown. The host device 110 may check the normal time information NRT in real time through the out-of-band communication.

At operation S360, the host device 110 may block the power supply voltage Vdd from being supplied to the storage device 120 in response to reading the normal time information NRT. The blocking of the power supply voltage Vdd by the host device 110 may be also referred to as external power-off.

At operation S370, the host device 110 may perform the power-on reset POR based on the normal time information NRT. For example, the host device 110 may supply the power supply voltage Vdd to the storage device 120 at a normal time point indicated by the normal time information NRT.

FIG. 10 is a flowchart describing examples of operations of FIG. 9, according to some embodiments of the present disclosure. Referring to FIGS. 9, and 10, operation S331a, operation S332a, and operation S333a may correspond to operation S330. Operation S341a may correspond to operation S340.

At operation S331a, the storage device 120 may measure the second device temperature value Td2 at the second time point Tp2. The second time point Tp2 may be after the thermal shutdown is performed.

At operation S332a, the storage device 120 may measure the third device temperature value Td3 at the third time point Tp3. The third time point Tp3 may be after the second time point Tp2.

At operation S333a, the storage device 120 may calculate the temperature trend information TTR based on the second device temperature value Td2 and the third device temperature value Td3. The temperature trend information TTR may include the temperature trend function describing the relationship between one or more times and one or more temperatures of the storage device 120. Operation S333a may include operation S333a-1 and operation S333a-2.

At operation S333a-1, the storage device 120 may obtain slope information based on the second device temperature value Td2 and the third device temperature value Td3. For example, the storage device 120 may obtain a first difference value by subtracting the second device temperature value Td2 from the third device temperature value Td3, may obtain a second difference value by subtracting the second time point Tp2 from the third time point Tp3, and may obtain the slope information by dividing the first difference value by the second difference value.

At operation S333a-2, the storage device 120 may obtain the temperature trend function describing the relationship between the time and the temperature of the storage device 120, based on the slope information. For example, the temperature trend function may be a linear function. The temperature trend function may be defined by the slope information and intercept information. In other words, the temperature trend information TTR may include the slope information and the intercept information.

At operation S341a, the storage device 120 may calculate the normal time information NRT indicating a normal time point based on the temperature trend function and the normal temperature value Tn. For example, the storage device 120 may obtain the normal time point mapped to the normal temperature value Tn on the temperature trend function. The storage device 120 may store the normal time information NRT indicating the normal time point.

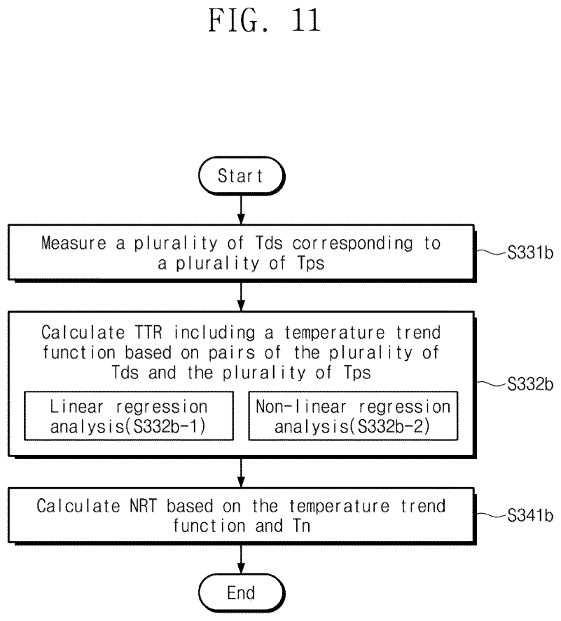

FIG. 11 is a flowchart describing examples of operations of FIG. 9, according to some embodiments of the present disclosure. Referring to FIGS. 9, and 11, operation S331b and operation S332b may correspond to operation S330. Operation S341b may correspond to operation S340.

At operation S331b, the storage device 120 may measure or obtain a plurality of device temperature values Tds corresponding to a plurality of points in time Tp. The plurality of time points Tp may be arbitrary different points in time after the thermal shutdown is performed. One of the plurality of device temperature values Td may be the second device temperature value Td2 at operation S330.

At operation S332b, the storage device 120 may calculate the temperature trend information TTR including the temperature trend function describing the relationship of a time and a temperature of the storage device 120, based on the plurality of time points Tp and the plurality of device temperature values Td. In some embodiments, the temperature trend information may be described as at least one of representing the relationship, and indicating the relationship.

In some embodiments, operation S332b may include S332b-1. For example, the storage device 120 may assume that a time and a temperature have a linear relationship after the thermal shutdown. At operation S332b-1, the storage device 120 may calculate temperature trend information including the temperature trend function through a linear regression analysis which is based on pairs of the plurality of points in time Tp and the plurality of device temperature values Td. The linear regression analysis may use a mean squared error (MSE) manner.

In some embodiments, operation S332b may include S332b-2. For example, the storage device 120 may assume that a time and a temperature have a non-linear relationship after the thermal shutdown. At operation S332b-2, the storage device 120 may calculate temperature trend information including the temperature trend function through a non-linear regression analysis which is based on pairs of the plurality of points in time Tp and the plurality of device temperature values Td.

At operation S341b, the storage device 120 may calculate the normal time information NRT indicating a normal time point based on the temperature trend function and the normal temperature value Tn. For example, the storage device 120 may obtain the normal time point mapped to the normal temperature value Tn on the temperature trend function. The storage device 120 may store the normal time information NRT indicating the normal time point.

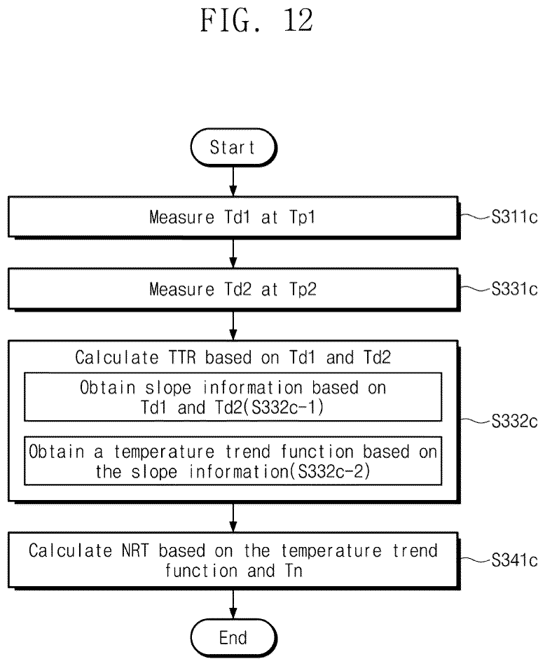

FIG. 12 is a flowchart describing examples of operations of FIG. 9, according to some embodiments of the present disclosure. Referring to FIGS. 9, and 12, operation S311c may correspond to operation S310. Operation S331c and operation S332c may correspond to operation S330. Operation S341c may correspond to operation S340.

At operation S311c, the storage device 120 may measure the first device temperature value Td1 at the first time point Tp1. The storage device 120 may determine that the first device temperature value Td1 exceeds the threshold temperature value Tth. The first device temperature value Td1 exceeding the threshold temperature value Tth may trigger the thermal shutdown.

At operation S331c, the storage device 120 may measure the second device temperature value Td2 at the second time point Tp2. The second time point Tp2 may be after the thermal shutdown is performed.

At operation S332c, the storage device 120 may calculate the temperature trend information TTR based on the first device temperature value Td1 and the second device temperature value Td2. The temperature trend information TTR may include the temperature trend function describing the relationship between a time and a temperature of the storage device 120. Operation S332c may include operation S332c-1 and operation S332c-2.

At operation S332c-1, the storage device 120 may obtain slope information based on the first device temperature value Td1 and the second device temperature value Td2. For example, the storage device 120 may obtain the slope information by dividing a first difference value by a second difference value. In embodiments, the first difference value may represent a difference between the second device temperature value Td2 and the first device temperature value Td1, and the second difference value may represent a difference between the second time point Tp2 and the first time point Tp1.

At operation S332c-2, the storage device 120 may obtain the temperature trend function describing the relationship between the time and the temperature of the storage device 120, based on the slope information. For example, the temperature trend function may be a linear function.

At operation S341c, the storage device 120 may calculate the normal time information NRT indicating a normal time point based on the temperature trend function and the normal temperature value Tn. For example, the storage device 120 may obtain the normal time point mapped to the normal temperature value Tn on the temperature trend function. The storage device 120 may store the normal time information NRT indicating the normal time point.

According to an embodiment of the present disclosure, an electronic device configured to calculate normal time information and a method of operating the same are provided.

Also, a host device may determine whether thermal shutdown of a storage device occurs in real time by reading normal time information, which may indicate a normal time point at which a temperature of the storage device is estimated to reach a normal temperature, from the storage device through out-of-band communication and may again supply a power supply voltage at an accurate time point at which the storage device is capable of operating normally.

While some embodiments are described above, it will be apparent to those of ordinary skill in the art that various changes and modifications may be made thereto without departing from the spirit and scope of the present disclosure as set forth in the following claims.

What is claimed is:

1. A method of operating an electronic device including a storage device and a host device, the method comprising:
determining, by the storage device, whether a first device temperature value of the storage device exceeds a threshold temperature value;
performing, by the storage device, thermal shutdown of the storage device based on determining that the first device temperature value exceeds the threshold temperature value;
after the thermal shutdown is performed, calculating, by the storage device, temperature trend information using a second device temperature value of the storage device;
calculating, by the storage device, estimated time information indicating an estimated time point at which a temperature of the storage device is estimated to reach a predetermined temperature value, based on the temperature trend information;
reading, by the host device, the estimated time information from the storage device;
blocking, by the host device, a power supply voltage from the host device to the storage device based on the estimated time information; and
supplying, by the host device, the power supply voltage to the storage device at the estimated time point.

2. The method of claim 1, wherein the reading of the estimated time information comprises:
reading, by the host device, the estimated time information from the storage device in real time using out-of-band communication between the host device and the storage device.

3. The method of claim 1, wherein a processor of the host device and a storage controller of the storage device are configured to perform peripheral component interconnect express (PCIe)-based in-band communication, and
wherein a baseboard management controller (BMC) of the host device and a device management circuit of the storage device are configured to perform system management bus (SMBus)-based out-of-band communication.

4. The method of claim 3, wherein the device management circuit comprises a monitoring circuit and an electrically erasable programmable read only memory (EEPROM), and
wherein the method further comprises:
performing, by the monitoring circuit, the thermal shutdown,
obtaining, using the monitoring circuit, the second device temperature value from a temperature sensor of the storage device,
calculating, by the monitoring circuit, the temperature trend information,
calculating, by the monitoring circuit, the estimated time information; and
storing, by the EEPROM, the estimated time information as field replaceable unit (FRU) information, and
controlling, by the monitoring circuit, the EEPROM to provide the estimated time information to the host device using the out-of-band communication.

5. The method of claim 1, further comprising:
before the first device temperature value is measured by a temperature sensor of the storage device, supplying, by the host device, the power supply voltage to a power supply circuit included in the storage device; and
supplying, by the power supply circuit, an internal power supply voltage to a storage controller of the storage device based on the power supply voltage.

6. The method of claim 5, further comprising:
obtaining, by the storage controller, the first device temperature value from the temperature sensor of the storage device;
determining, by the storage controller, whether the first device temperature value exceeds the threshold temperature value; and
providing, by the storage controller, a warning message to a monitoring circuit included in the storage device based on determining that the first device temperature value exceeds the threshold temperature value.

7. The method of claim 5, wherein the performing of the thermal shutdown includes blocking the internal power supply voltage from being supplied from the power supply circuit to the storage controller.

8. The method of claim 1, further comprising:
measuring, by the storage device, the second device temperature value of the storage device at a first time point after the thermal shutdown is performed; and
measuring, by the storage device, a third device temperature value of the storage device at a second time point after the first time point,
wherein the temperature trend information is calculated by the storage device based on the second device temperature value and the third device temperature value.

9. The method of claim 8, wherein the calculating of the temperature trend information comprises obtaining, by the storage device, slope information by dividing a first difference value by a second difference value, wherein the first difference value represents a difference between the third device temperature value and the second device temperature value, and the second difference value represents a difference between the second time point and the first time point; and
calculating, by the storage device, a temperature trend function representing a relationship between times and temperatures of the storage device, based on the slope information,
wherein the temperature trend information comprises the temperature trend function.

10. The method of claim 9, wherein the estimated time information is calculated by the storage device based on the temperature trend function and the predetermined temperature value.

11. The method of claim 1, wherein the calculating of the temperature trend information comprises measuring, by the storage device, a plurality of device temperature values corresponding to a plurality of time points after the thermal shutdown is performed, wherein the second device temperature value is included in the plurality of device temperature values, and
wherein the temperature trend information is calculated by the storage device based on pairs of the plurality of time points and the plurality of device temperature values.

12. The method of claim 11, wherein the temperature trend information is calculated by the storage device using a linear regression analysis based on the pairs of the plurality of time points and the plurality of device temperature values.

13. The method of claim 11, wherein the temperature trend information is calculated by the storage device using a non-linear regression analysis based on the pairs of the plurality of time points and the plurality of device temperature values.

14. The method of claim 1, wherein the calculating of the temperature trend information comprises:
measuring, by the storage device, the second device temperature value of the storage device after the thermal shutdown is performed;
obtaining, by the storage device, slope information based on the first device temperature value and the second device temperature value; and
calculating, by the storage device, a temperature trend function representing a relationship between times and temperatures of the storage device, based on the slope information,
wherein the temperature trend information comprises the temperature trend function.

15. The method of claim 1, wherein the storage device comprises a monitoring circuit configured to perform the thermal shutdown, to obtain the second device temperature value from a temperature sensor of the storage device, to calculate the temperature trend information, and to calculate the estimated time information, and
wherein an auxiliary power supply voltage different from the power supply voltage is supplied to the monitoring circuit from the host device.

16. A method of operating an electronic device including a storage device and a host device, the method comprising:
determining, by the storage device, whether a first device temperature value of the storage device exceeds a threshold temperature value;
performing, by the storage device, thermal shutdown of the storage device based on determining that the first device temperature value exceeds the threshold temperature value;
after the thermal shutdown is performed, calculating, by the storage device, temperature trend information using at least two second device temperature values of the storage device;
calculating, by the storage device, estimated time information indicating an estimated time point at which a temperature of the storage device is estimated to reach a predetermined temperature value, based on the temperature trend information;
reading, by the host device, the estimated time information from the storage device using out-of-band communication between the host device and the storage device;
blocking, by the host device, a power supply voltage from being supplied from the host device to the storage device based on the estimated time information; and
performing, by the host device, a power-on reset for supplying the power supply voltage to the storage device at the estimated time point.

17. The method of claim 16, wherein the calculating of the temperature trend information comprises:
measuring, by the storage device, the at least two second device temperature values at least two time points, wherein the at least two time points are different from each other; and
calculating, by the storage device, a temperature trend function representing a relationship between times and temperatures of the storage device, based on pairs of the at least two time points and the at least two second device temperature values,
wherein the temperature trend information comprises the temperature trend function.

18. An electronic device comprising:
a storage device; and
a host device configured to supply a power supply voltage to the storage device,
wherein the storage device is configured to:
determine whether a first device temperature value that is increased based on the power supply voltage exceeds a threshold temperature value;
perform thermal shutdown based on determining that the first device temperature value exceeds the threshold temperature value;
calculate temperature trend information using a second device temperature value that is decreased from the first device temperature value based on the thermal shutdown; and
calculate estimated time information indicating an estimated time point at which a temperature of the storage device is estimated to reach a predetermined temperature value, based on the temperature trend information, and
wherein the host device is further configured to:
read the estimated time information from the storage device;
block the power supply voltage based on the estimated time information; and
begin supplying the power supply voltage to the storage device again at the estimated time point.

19. The electronic device of claim 18, wherein the storage device comprises:
a power supply circuit configured to receive the power supply voltage from the host device and to generate an internal power supply voltage;
a temperature sensor configured to measure the first device temperature value and the second device temperature value;
a storage controller powered by the internal power supply voltage, wherein the storage controller is configured to:
obtain the first device temperature value from the temperature sensor,
determine whether the first device temperature value exceeds the threshold temperature value, and
generate a warning message based on determining that the first device temperature value exceeds the threshold temperature value;
a monitoring circuit configured to:
perform the thermal shutdown by blocking the internal power supply voltage based on the warning message,
obtain the second device temperature value from the temperature sensor,
calculate the temperature trend information using the second device temperature value, and
calculate the estimated time information based on the temperature trend information; and
an electrically erasable programmable read only memory (EEPROM) configured to store the estimated time information as field replaceable unit (FRU) information,
wherein the monitoring circuit is further configured to control the EEPROM to provide the estimated time information to the host device using out-of-band communication.

20. The electronic device of claim 19, wherein the host device comprises:
a processor configured to perform peripheral component interconnect express (PCIe)-based in-band communication with the storage controller of the storage device; and
a baseboard management controller (BMC) configured to perform the out-of-band communication, which is based on a system management bus (SMBus), with the EEPROM of the storage device.
